(19) United States
(12) Patent Application Publication
(10) Pub. No.: US 2004/0202158 A1
(43) Pub. Date: Oct. 14, 2004

(54) Packet communication network and packet transfer control method

(76) Inventors: Hirokazu Takeno, Yokohama (JP); Mitsuo Igari, Yokohama (JP); Takeshi Amada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 09/791,807

(22) Filed: Feb. 26, 2001

(30) Foreign Application Priority Data
Dec. 18, 2000 (JP) 2000-383432

(51) Int. Cl. H04L 12/28

(52) U.S. Cl. 370/389; 370/395.1

(57) ABSTRACT

A communication network constructed by a plurality of packet transfer apparatuses each having a function of autonomously setting routing information in a routing table. Each of the packet transfer apparatuses has a function of setting routing information designated by a management apparatus into a routing table and places priority on the routing information designated by the management apparatus over the routing information autonomously set, thereby to transferring received packets from a user who has reserved a bandwidth through an optimum route in which the bandwidth can be guaranteed.

### BACKGROUND OF THE INVENTION

1. Field of the Invention

The present invention relates to a packet communication network and a packet transfer control method. More particularly, the invention relates to a packet communication network, a packet transfer apparatus, and a packet transfer control method for transferring a variable length packet typified by an IP (Internet Protocol) packet.

2. Description of the Related Art

Route selecting methods in a packet communication network include: a method in which each of packet transfer apparatuses exchanges topology information with neighboring packet transfer apparatuses and autonomously selects a route; and a method of collecting network information including topology information in a network management apparatus or a specific packet transfer apparatus and selecting packet transfer routes from a source point to a destination point in a lump by the management apparatus or specific packet transfer apparatus.

Examples of the former method are RIP (Routing Information Protocol) and OSPF (Open Shortest Path First protocol) for selecting a route having the minimum number of packet transfer apparatuses. Japanese Unexamined Patent Application (JP-A) No. 11-154981 discloses a method capable of selecting a plurality of backup routes in the OSPF. As the latter method, for example, in JP-A-10-126439, a method of selecting a route of a largest line capacity by a packet transfer apparatus at the source point of the route is proposed. In JP-A-11-239181, a method of measuring delay time in packet transmission and selecting a route of a shortest delay time by a management apparatus is proposed.

In a conventional connectionless packet communication network directed to a variable length packet, communication starts without designating a packet transfer route in advance. Consequently, only communication service based on the presumption that the number of transmittable/receivable packets varies depending on the status of a communication network is provided. That is, communication service with “guarantee of bandwidth” of always guaranteeing the number of transmittable/receivable packets is not provided. However, in association with a rapid increase in packet communication amount and variety of information carried by packets in recent years, a demand on the guarantee of bandwidth is increasing.

In order to realize the guarantee of bandwidth in a variable length packet communication network, it is necessary to grasp the communication status of the whole communication network. In the method of autonomously selecting a route by each of packet transfer apparatuses, however, each packet transfer apparatus can collect only topology information of neighboring apparatuses, so that the communication status of the whole network cannot be grasped.

On the other hand, although the method of selecting a route by a network management apparatus is adapted to realize the guarantee of bandwidth, in a communication form in which a communication partner changes frequently like in the Internet connection, there is a problem such that a process load on the management apparatus increases for route selection. As the scale of a communication network is enlarging and the network configuration is becoming more complicated, a problem such that time required for route selection increases arises.

Generally, traffic in a packet communication network varies according to time zones. In order to efficiently use network resources, therefore, it is desirable to select a route in consideration of a time zone of using the route to be set. In conventional techniques, however, a route is selected on the basis of the status of a communication network at the time point of route selection or information which does not change with time. Consequently, there is a problem such that the resources of a communication network cannot be efficiently used. A method of setting destinations one by one from a source node to a destination node in the case where a packet transfer apparatus autonomously sets a route has been also proposed. The method, however, has a problem such that when the scale of a communication network increases, time required to set a route becomes long.

### SUMMARY OF THE INVENTION

An object of the invention is to provide a variable length packet communication network, a packet transfer apparatus, and a packet transfer control method capable of guaranteeing a bandwidth in a specific route.

Another object of the invention is to provide a variable length packet communication network, a packet transfer apparatus, and a packet transfer control method capable of guaranteeing a bandwidth with respect to a bandwidth-reserved connection.

Further another object of the invention is to provide a variable length packet communication network, a packet transfer apparatus, and a packet transfer control method for transferring a packet by selectively using routing information autonomously collected by a transfer apparatus and routing information designated by a management apparatus.

In order to achieve the objects, a packet transfer apparatus according to the invention has: a function of autonomously collecting routing information in a routing table; a function of setting routing information designated by a management apparatus into the routing table, and a function of routing received packets by placing priority on the routing information designated by the management apparatus over the routing information autonomously set, thereby enabling received packets from the user who has reserved a bandwidth through an optical route in which the bandwidth can be guaranteed.

According to the invention, there is provided a packet transfer control method in a communication network constructed by a plurality of packet transfer apparatuses connected to a management apparatus, each of the packet transfer apparatuses executing the steps of: updating a routing table on the basis of routing information designated by the management apparatus; autonomously collecting routing information and updating the routing table; and routing a received packet with reference to the routing table by giving priority on the routing information designated by the management apparatus over the routing information autonomously collected.

In an embodiment of the invention, line information including a line identification and traffic status information is notified from each of the packet transfer apparatuses to the management apparatus and the management apparatus stores the line information notified from each of the packet transfer apparatuses. When a bandwidth reservation request in which a source point and a destination point of a connection are designated is received from the outside, the management apparatus selects an optimum route adapted to the request from the stored line information of a predetermined period, and instructs each of packet transfer apparatuses on the optimum route to set routing information for transferring a transmission packet based on the bandwidth reservation through the optimum route.

In a preferred embodiment of the invention, the management apparatus stores traffic information notified from each of the packet transfer apparatuses as traffic information for each of time zones and, when the bandwidth reservation request is received, selects an optimum route for the request on the basis of traffic information corresponding to a use time zone in the reserved bandwidth.

According to another feature of the invention, the management apparatus comprises a plurality of sub management apparatuses each connected to a group of packet transfer apparatuses which form a subnetwork and, a main management apparatus connected to the plurality of sub management apparatuses, and the main management apparatus determines a route among subnetworks, and each of the sub management apparatuses to which an instruction from the main management apparatus is given determines a route within the subnetwork under the control of the sub management apparatus and notifies routing information to each of packet transfer apparatuses on the route within the subnetwork.

A packet communication network of the invention has: a plurality of packet transfer apparatuses each belonging to any of subnetworks constructing a packet communication network; a plurality of sub management apparatuses each connected to a group of packet transfer apparatuses included in a subnetwork controlled by the sub management apparatus; and a main management apparatus connected to the plurality of sub management apparatuses. The main management apparatus has means for determining a route among subnetworks with respect to a connection for which a bandwidth is reserved and instructing each of sub management apparatuses controlling subnetworks on the route to select a route within the subnetwork. The sub management apparatus has: means for determining a route within the subnetwork controlled by the sub management apparatus in response to the route selection instruction from the main management apparatus; and means for instructing each of packet transfer apparatuses on the route in the subnetwork to set routing information.

A packet transfer apparatus of the invention comprises: a routing table for storing routing information in correspondence with destination information to be included in a header of a received packet; means for autonomously collecting the routing information in cooperation with other packet communication apparatuses forming a communication network and for updating the routing table; means for updating the routing table on the basis of routing information designated by the sub management apparatus; and means for determining a destination of a received packet with reference to the routing table by giving priority on the routing information designated by the management apparatus over the routing information autonomously collected and routing the received packet to any of the output ports.

### BRIEF DESCRIPTION OF THE DRAWINGS

FIG. 1 is a diagram showing an example of a packet communication network to which the invention is applied.

FIG. 2 is a diagram showing a schematic configuration of a packet transfer apparatus (router) included in the communication network of FIG. 1.

FIGS. 3A and 3B are diagrams each showing an example of a routing table of the packet transfer apparatus.

FIG. 4 is a diagram showing the configuration of each of a main management apparatus 100 and a sub-management apparatuses 11, 12, 13, . . . included in the communication network of FIG. 1.

FIG. 5 is a diagram showing an example of a router management table 50 of the sub-management apparatus.

FIG. 6 is a diagram showing an example of an inter-router path selection table 500 generated by a sub-management apparatus.

FIG. 7 is a diagram showing an example of a subnetwork management table 60 of the main management apparatus.

FIG. 8 is a diagram showing an example of a subnetwork bandwidth management table 70 of the main management apparatus.

FIG. 9 is a diagram showing an example of an inter-subnetwork path selection table 600 generated by the main management apparatus.

FIG. 10 is a diagram showing an example of a subnetwork selection table 700 generated by the main management apparatus.

FIG. 11 is a flowchart showing an example of a subnetwork status notification program 200 executed by a sub management apparatus.

FIG. 12 is a flowchart showing an example of a bandwidth reservation program 110 executed by the main management apparatus.

FIG. 13 is a format diagram showing an example of a control message for route selection/setting issued from the main management apparatus to a sub management apparatus.

FIG. 14 is a flowchart showing an example of an inter-subnetwork path selection program 210 executed by a sub management apparatus.

### DESCRIPTION OF THE PREFERRED EMBODIMENTS

Embodiments of the invention will be described hereinbelow with reference to the drawings.

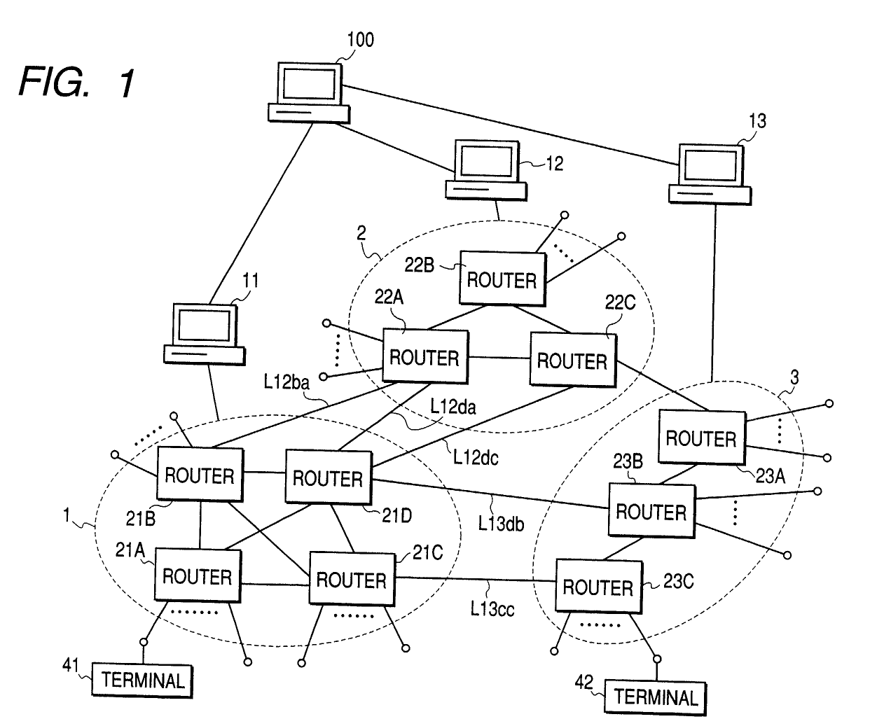

FIG. 1 shows an example of a packet communication network to which the invention is applied.

A packet communication network is comprised of a plurality of subnetworks 1, 2, 3, . . . . Each subnetwork includes a plurality of packet transfer apparatuses, for example, routers. Each of sub management apparatuses 11, 12, and 13 is disposed for each of the subnetworks and is connected to a main management apparatus 100.

In the example, the subnetworks 1, 2, and 3 include routers 21A to 21D, 22A to 22C, and 23A to 23C, respectively. Each router is connected to the other routers in the subnetwork and routers in other subnetworks or packet communication terminals (41, 42, . . . ). Although each subnetwork includes three to four routers in the diagram, the scale of a subnetwork can be freely determined according to the capability of a sub management apparatus or the convenience of a network manager.

Each of the sub management apparatuses 11, 12, 13, . . . communicates with the routers in the subnetwork under its control to collect traffic information from each of the routers and report traffic statuses in the subnetwork under its control to the main management apparatus 100. Each of the sub management apparatuses 11, 12, 13, . . . selects an optimum route within the subnetwork under its control in response to a route selecting/setting instruction from the main management apparatus 100, and instructs route setting to each of routers on the optimum route.

The main management apparatus 100 and each of the sub management apparatuses 11, 12, 13, . . . communicate with each other, for example, via a control network. When there is no problem in reliability, in place of the control network, any of general communication networks including the subnetworks 1, 2, 3, . . . may be used.

When the scale of the communication network becomes larger and the number of sub management apparatuses 11, 12, 13, . . . increases, the group of management apparatuses may have a hierarchical structure by dividing the sub management apparatuses into a plurality of groups, disposing an intermediate management apparatus for controlling an enlarged subnetwork for each group, and connecting the intermediate management apparatus to the main management apparatus 100. In this case, route selection in each subnetwork and an explicit route setting instruction to the routers are performed by the management apparatuses in the lowest layer (sub management apparatuses 11, 12, 13, . . . ), and a logical route between subnetworks is selected by the management apparatuses in the upper layers.

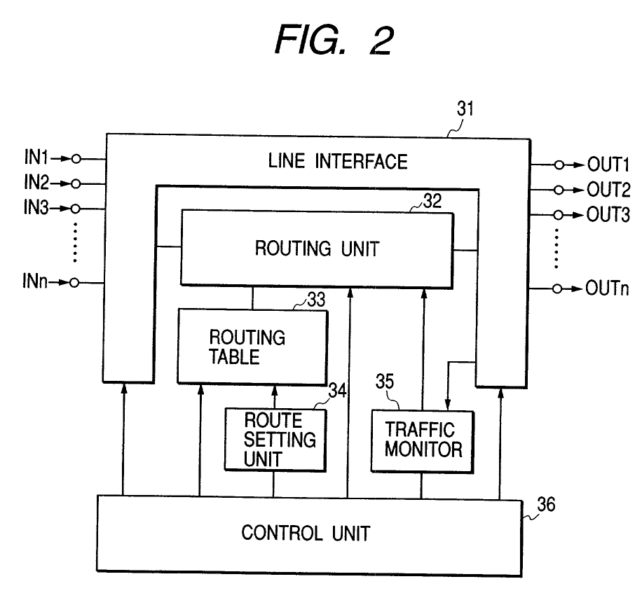

FIG. 2 shows the configuration of the router 21A. Each of the other routers 21B, . . . 23C shown in FIG. 1 has a configuration basically similar to that of the router 21A.

The router 21A has: a line interface 31 connected to input ports IN1 to INn and output ports OUT1 to OUTn; a routing unit 32 for selectively transferring a received packet from the input ports IN1 to INn to the output ports OUT1 to OUTn; a routing table 33 showing the corresponding relation between destination information included in a packet header and an output port as a destination of the packet; a route setting unit 34 for autonomously setting a route by exchanging topology information with other neighboring routers by a routing protocol such as RIP or OSPF; a traffic monitor 35 for monitoring a traffic amount of each output line on the basis of the number of packets passing through the line interface 31 and the packet size; and a control unit 36 connected to the elements.

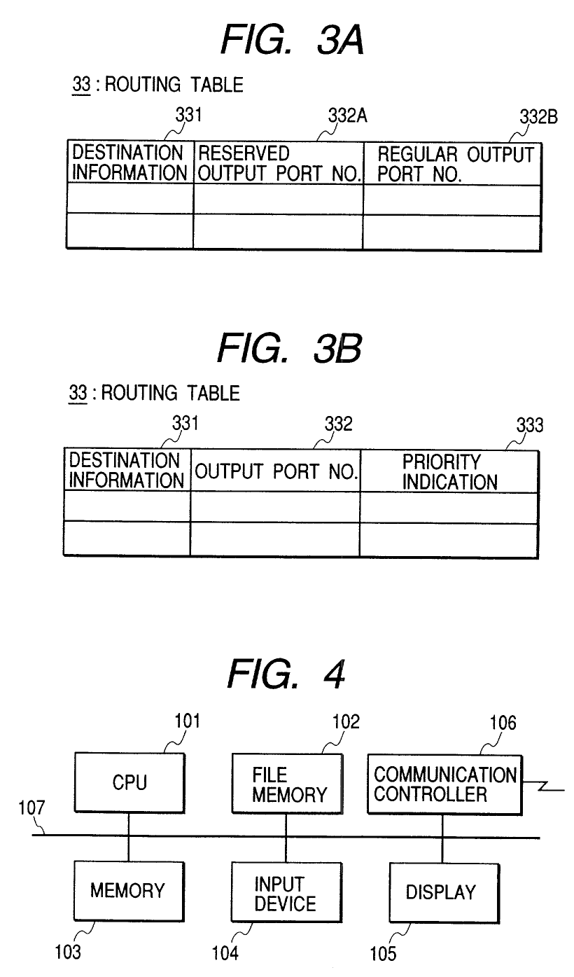

The routing table 33 has, for example, as shown in FIG. 3A, a plurality of entries each including reserved output port number 332A and regular output port number 332B in correspondence with destination information 331. The destination information 331 is, for example, shortened address information obtained by masking a part of a destination address of each received packet. The reserved output port number 332A indicates an output port on a route designated by the sub management apparatus, and the regular output port number 332B indicates an output port on a route autonomously selected by the route setting unit 34.

When a packet is received from the line interface 31, the routing unit 32 searches the routing table 33 on the basis of a destination address included in the packet header, and retrieves an entry of which destination information 331 matches the destination address. If the reserved output port number 332A is defined in the entry, the received packet is transferred to the output port indicated by the reserved output port number 332A. When the reserved output port number 332A is not defined yet, the received packet is transferred to the output port indicated by the regular output port number 332B.

In the invention, in each of the entries in the routing table 33, for example, as shown in FIG. 3B, it is also possible to define output port number 332 and a priority indication bit 333 in correspondence with the destination information 331 and transfer a received packet to the output port indicated by the output port number 332.

The priority indication bit 333 indicates whether the output port number 332 is designated by the sub management apparatus or set autonomously by the route setting unit 34. For example, when the output port number 332 matches the reserved output port number 332A, “1” is set as the priority indication bit 333. When the output port number 332 corresponds to the regular output port number 332B, “0” is set as the priority indication bit 333.

In this case, at the time of updating the routing table 32 by the route setting unit 34, an entry having “1” as the priority indication bit 333 is not regarded as a target to be updated, thereby giving priority on a route designated by the sub management apparatus over a route autonomously selected by the route setting unit 34.

The traffic status of each line monitored by the traffic monitor 35 is periodically notified to the sub management apparatus 11 via the control unit 36. Each router may notify the traffic status in response to a request from the sub management apparatus. It is sufficient to set a method of notifying the traffic status from each router to a sub management apparatus and a notification interval in accordance with an operation policy of the network.

The traffic status can be expressed, for example, as an average communication data amount transmitted to each output line in a unit time. For example, lengths of packets transferred in a predetermined period are summed up and a traffic amount per unit time is calculated. In a network in which a line use rate hardly changes, a measurement value notified last time is held in each router. Only when a new measurement value is different from the measurement value of last time, a traffic amount is notified to the sub management apparatus. In such a manner, the amount of data transferred between each router and the sub management apparatus can be suppressed. In a network where the line use rate does not fluctuate largely and fluctuates finely, it is also possible to divide the traffic amount into a plurality of levels and notify the level number from a router to a sub management apparatus. As the value of the traffic amount notified to the sub management apparatus, in a network requiring strict guarantee of bandwidth, in place of an average data amount of a predetermined period, the maximum traffic value in the period may be used.

FIG. 4 shows the configuration of each of the sub management apparatuses 11, 12, 13, . . . .

The sub management apparatus has a CPU 101, a file memory 102 in which data and various programs are stored, a memory 103 used as a work area for computing, an input device 104 such as a keyboard or mouse operated by the operator, a display 105, and a communication controller 106 for connection to a communication line.

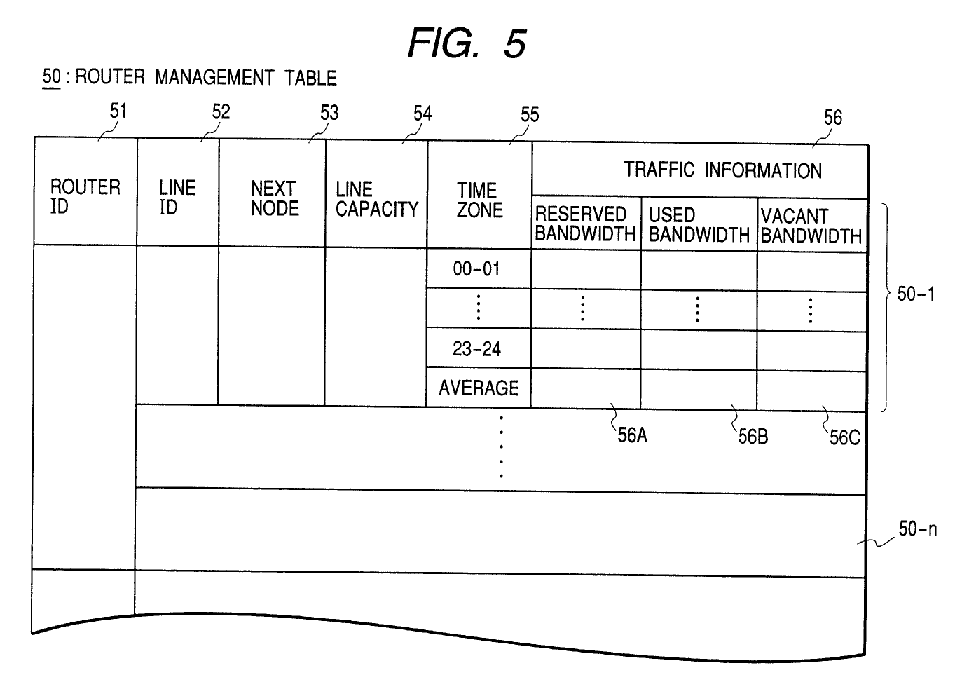

Each sub management apparatus is provided with, in the file memory 102, for example, a router management table 50 shown in FIG. 5, and a network status notification program 200 and an inter-subnetwork path selection program 210 which will be described hereinlater.

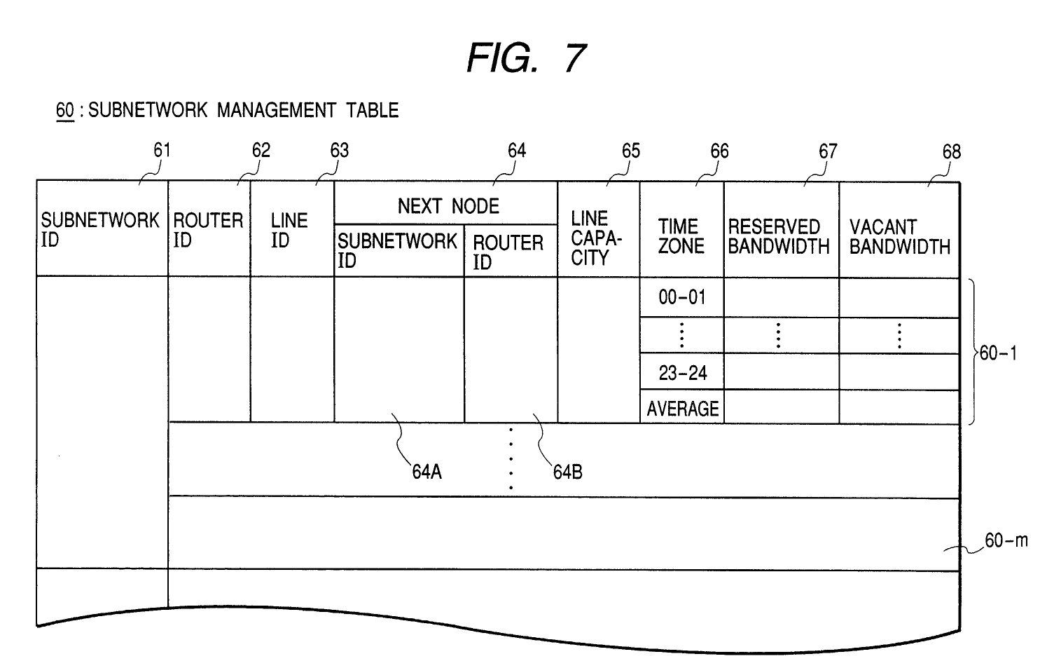

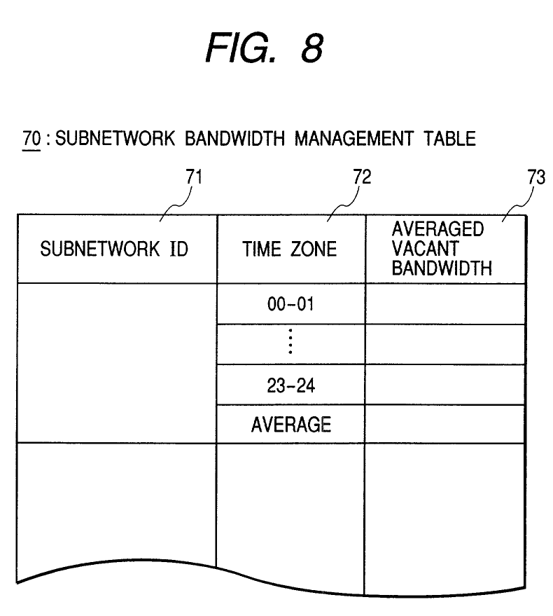

The main management apparatus 100 also has a configuration similar to that of the sub management apparatus. In the file memory 102, for example, a subnetwork management table 60 shown in FIG. 7, a subnetwork bandwidth management table 70 shown in FIG. 8, and a line reservation processing program which will be described hereinlater are stored.

FIG. 5 shows the router management table 50 provided for each sub management apparatus.

The router management table 50 includes a plurality of line information entries 50-1 to 50-n in correspondence with an identification (ID) of router 51 belonging to a subnetwork under the control of the sub management apparatus. Each line information entry 50-i (i=1 to n) is comprised of a line ID (output port ID) 52, next node information 53, line capacity 54, and traffic information record 56 for each time zone 55. The next node information 53 includes, for example, an ID of another router connected to an output port indicated by the line ID 52 and an ID of a subnetwork to which the other router belongs. The traffic information record 56 for each time zone 55 has, for example, reserved bandwidth (reserved line capacity) 56A designated by the main management apparatus 100, a used bandwidth (used line capacity) 56B, and a vacant bandwidth (available line capacity) 56C.

The router ID 51, line ID 52, and line capacity 54 are set by a network manager at the time of constructing the network or changing the configuration of the network. These values may be automatically obtained by the sub management apparatus from each router with a management protocol such as SNMP (Simple Network Management Protocol) and set in the table 50. The next node information 53 is also set by the manager at the time of constructing the network or changing the configuration of the network. It is also possible to automatically obtain data by the sub management apparatus and set it in the table 50 in a manner similar to a network topology drawing function known as the function of a network management apparatus.

The vacant bandwidth (available line capacity) 56C denotes a value obtained by subtracting the used bandwidth 56B from the line capacity 54. The used bandwidth 56B indicates an actual traffic amount for each time zone notified from each router, and is a measurement value in which a traffic amount with a bandwidth reservation and a traffic amount with no bandwidth reservation are mixed. In the embodiment, one day is divided into 24 time zones each having one hour. In the last record, an average value of each of the reserved bandwidth 56, used bandwidth 57, and vacant bandwidth 58 of one day is shown.

As will be described hereinlater, reservation of a bandwidth is realized by entering connection setting information by the network manager to the main management apparatus 100, selecting an optimum route among subnetworks by the main management apparatus 100, instructing inter-subnetwork path selection from the main management apparatus 100 to each of the sub management apparatuses on the selected routes, and selecting the optimum route within the subnetwork under the control of each of the sub management apparatuses. Since the bandwidth is reserved by designating date and time in future with respect to the current time point, the main management apparatus and each of the sub management apparatuses manage reserved time zone and routing information in correspondence with the term of using the reserved bandwidth.

In each of the sub management apparatuses, the router management table 50 shown in FIG. 5 is generated every day, and the reserved bandwidth 56A in each time zone is updated in accordance with a newly generated reserved bandwidth and the use term of an existing reserved bandwidth. According to the traffic status information notified from each router, values of the used bandwidth 56B and the vacant bandwidth 56C in the time zone are updated. When the table is generated, the used bandwidth 56B and the vacant bandwidth 56C in each time zone are blank. As the traffic status information is collected from a router, actual record data is subsequently stored in each time zone.

Each sub management apparatus selects the optimum route within the subnetwork by using the router management table 50 in response to the route selection/setting instruction from the main management apparatus 100. The optimum route selected here is based on the presumption that it will be used later than the current time point. Consequently, the optimum route cannot be selected based on only the router management table 50 being updated at present indicative of a past traffic status.

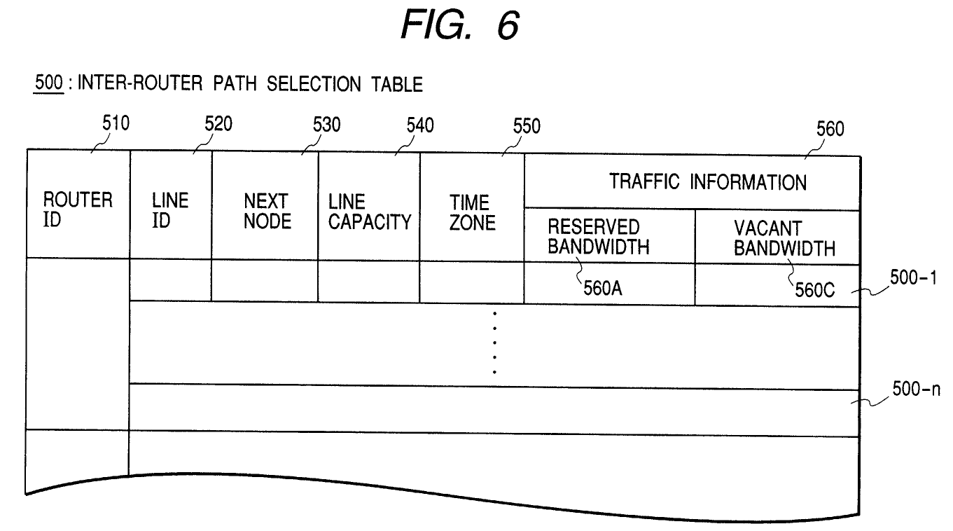

In the invention, therefore, the router management table 50 of a past predetermined period is stored and, on selection of the optimum route, an inter-router path selection table 500 shown in FIG. 6 is generated from the past accumulated data. In the inter-router path selection table 500, vacant bandwidth 560C in reserved time zone 550 on a reserved bandwidth use start day is expressed in a statistic value calculated from the actual record data of the past predetermined period. On the basis of the table, the optimum route in the subnetwork satisfying the reserved bandwidth is selected.

The inter-router path selection table 500 includes a plurality of line information entries 500-1 to 500-n in correspondence with a router ID 510. Each line information entry 500-i (i=1 to n) has line ID (output port ID) 520, next node information 530, line capacity 540, and traffic information record 560 in a reserved time zone 550. The traffic information record 560 includes a reserved bandwidth 560A and a vacant bandwidth 560C expressed as a statistic value. In this case, as a statistic value of the vacant bandwidth 560C, for example, an average value of actual record values of the vacant bandwidth 56C in a past predetermined period can be employed. In place of the average value, for example, a minimum value measured in a past predetermined period may be also used.

The route management table 50 may have a format different from that in the embodiment as long as a change with time in line capacity, next node, reserved bandwidth, and vacant bandwidth can be held for each line with respect to each router.

FIG. 7 shows the structure of the subnetwork management table 60 provided for the main management apparatus 100.

The subnetwork management table 60 includes a plurality of line information entries 60-1 to 60-m in correspondence with a subnetwork ID 61. Each line information entry 60-i (i=1 to m) is used to define an inter-subnetwork connection line and indicates the status of traffic and is comprised of an ID 62 of a router (hereinbelow, called an edge router) connected to another subnetwork, an ID 63 of an inter-subnetwork connection line of the edge router, next node information 64, line capacity 65, and traffic information record for each of time zones 66.

The next node information 64 includes an ID 64A of another subnetwork to which a connection line (output line) having the line ID 63 is connected and an ID 64B of a router. In this example, one day is divided into 24 time zones each having one hour. Traffic information record indicates a reserved bandwidth 67 and a vacant bandwidth 68 in each time zone 66. In the last traffic information record, an average value of one day of each of the reserved bandwidth 67 and that of the vacant bandwidth 68 are shown.

FIG. 8 shows the structure of the subnetwork bandwidth management table 70 in the main management apparatus 100.

The subnetwork bandwidth management table 70 includes a plurality of information records in correspondence with IDs 71 of subnetworks. In this example, one day is divided into 24 time zones each having one hour. In each information record, an averaged vacant bandwidth 73 in the subnetwork is indicated for each time zone 72. In the last record, an average vacant bandwidth of one day is shown.

The subnetwork management table 60 and the subnetwork bandwidth management table 70 are, in a manner similar to the router management table 50, prepared every day and updated in accordance with the subnetwork status notification received from the sub management apparatus.

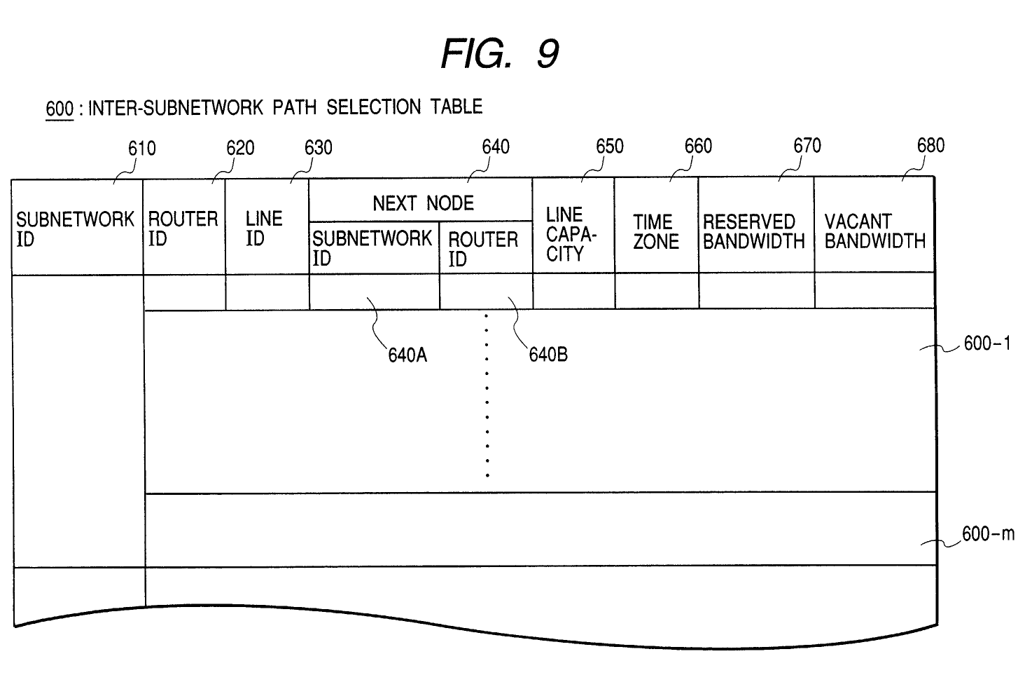

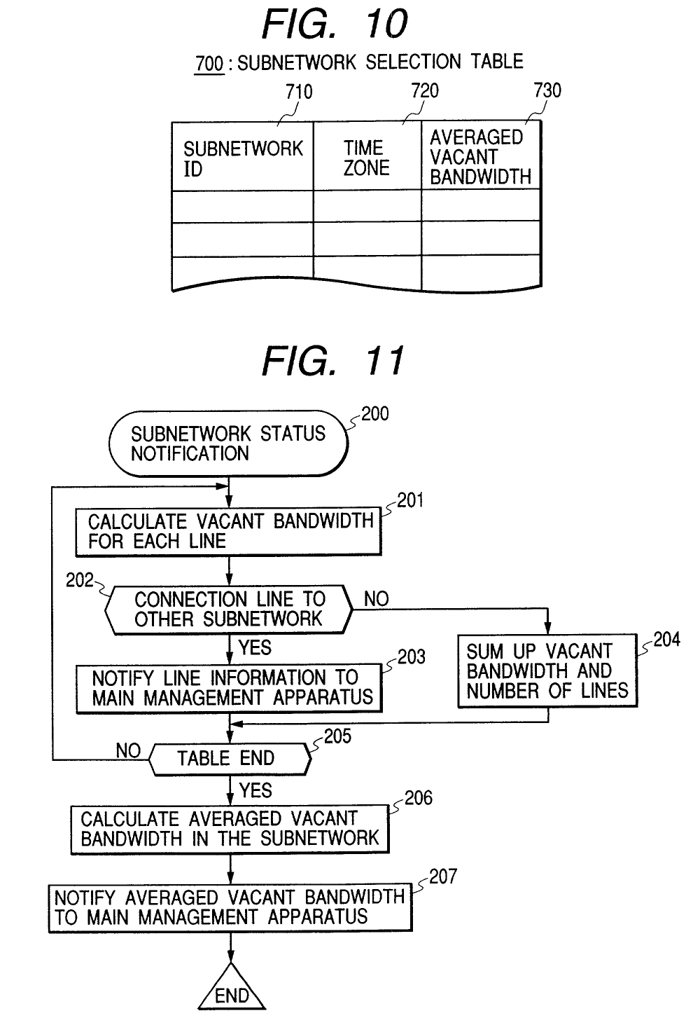

At the time of bandwidth reservation, the main management apparatus 100 generates, for example, an inter-subnetwork path selection table 600 shown in FIG. 9 and a subnetwork selection table 700 shown in FIG. 10, and selects an optimum route between subnetworks on the basis of these tables.

The inter-subnetwork path selection table 600 expresses a vacant bandwidth 680 of a line connecting subnetworks in a specific time zone 650 in which a bandwidth is to be reserved as a statistic value calculated from actual record data of the vacant bandwidth 68 indicated in the subnetwork management table 60 of a past predetermined period. The subnetwork selection table 700 expresses an average vacant bandwidth 670 in the subnetwork in the bandwidth-reserved specific time zone 720 as a statistic value calculated from actual record data of the vacant bandwidth 73 indicated in the subnetwork bandwidth management table 70 of the past predetermined period.

FIG. 11 shows a flowchart of the subnetwork status notification program 200 executed by the CPU 101 in each of the sub management apparatuses 11, 12, 13, . . . .

The sub management apparatus periodically collects traffic status information of each line from each of routers in the subnetwork under its control, and updates the used bandwidth 56B for each time zone in the router management table 50 shown in FIG. 5. The used bandwidth of each line can be obtained by monitoring packets passing through each output line by the traffic monitor 35 of the router, accumulating packet lengths, and converting the packet lengths into a communication data amount per unit time. As the used bandwidth 56B, a value calculated on the router side for each time zone 55 may be notified to the sub management apparatus, or an amount of data passed each line may be notified from each router to the sub management apparatus and converted to a value of the used bandwidth 56B for each time zone 55 on the sub management apparatus side.

The sub management apparatus executes the subnetwork status notification program 200 either voluntarily or in response to a request from the main management apparatus 100 and notifies the traffic status of each of routers under its control to the main management apparatus 100.

In the subnetwork status notification program 200, the line information entries 50-i (i=1 ton) registered in correspondence with the router IDs 51 in the router management table 50 are sequentially selected and the value of the used bandwidth 56B is subtracted from the value of the line capacity 54 of the selected line information entry, thereby calculating the value of the average vacant bandwidth 56C for each time zone or each day (step 201) Subsequently, the next node information 53 in the line information entry is checked (step 202). When the entry is for a line connected to another subnetwork, the router ID 51 and the data in the line information entry 50-i are notified in the form of a control message to the main management apparatus 100 (step 203). If the entry is for a line connected to another router in its subnetwork or a terminal, vacant bandwidths are summed up for each time zone on a work table defined in the memory 103, and a parameter value indicative of the number of lines is incremented (step 204).

After the steps 201 to 204 are repeated on effective line information entries included in the router management table 50 and processes are completed with respect to all the line information entries (step 205), an average vacant bandwidth for each time zone in the subnetwork is calculated by dividing the cumulative vacant bandwidth value of each time zone stored in the work table by the number of lines (step 206). The average vacant bandwidth is notified in the form of a control message to the main management apparatus 100 (step 207).

In the flowchart, with respect to the inter-subnetwork connection line, the line information entry 50-i for each line is notified to the main management apparatus 100 in step 203. It is also possible to store the contents of the line information entry 50-i in a work area in correspondence with the router ID 51 in step 203 and notify a plurality of line information entries stored in the work area in a lump to the main management apparatus 100 in step 206. It is also possible to notify a plurality of line information entries stored in the work area in a lump to the main management apparatus 100 when the router ID 51 changes.

When the control message including the line information entry of the inter-subnetwork connection line is received from the sub management apparatus, the main management apparatus 100 updates the subnetwork management table 60 shown in FIG. 7 in accordance with the contents of the received message. When the control message indicative of the average vacant bandwidth for each time zone in the subnetwork is received from the sub management apparatus, the subnetwork bandwidth management table 70 shown in FIG. 8 is updated according to the contents of the received message.

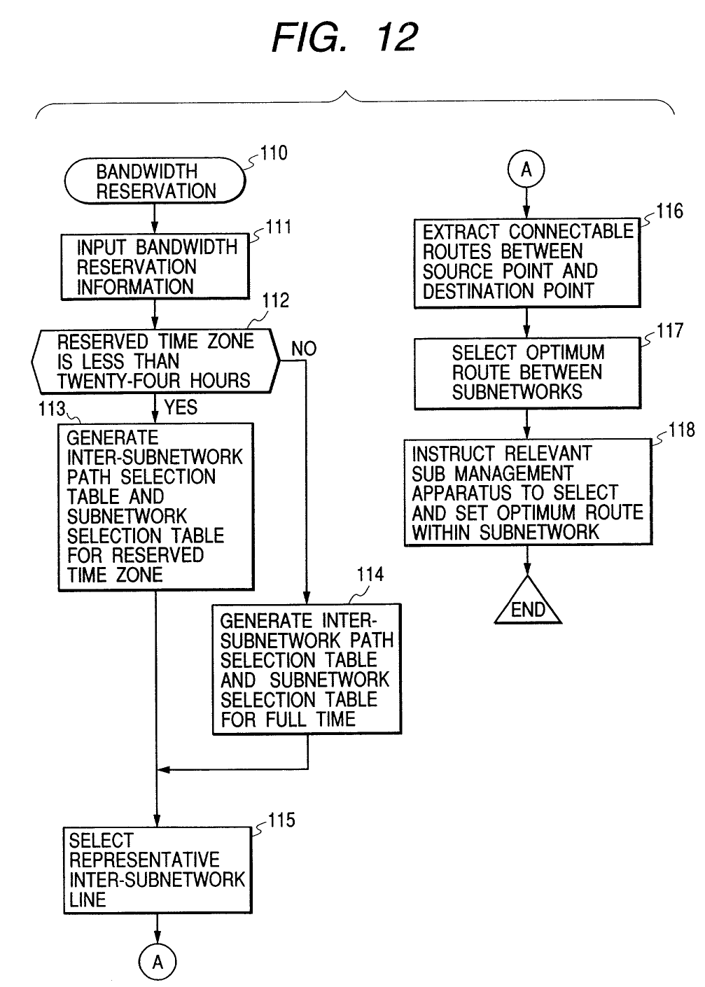

FIG. 12 shows a flowchart of a bandwidth reservation program 110 executed by the main management apparatus 100.

The bandwidth reservation program 110 is started by an input operation by the network manager. The network manager enters information such as source point information and destination point information of a connection to be bandwidth-reserved, reserved bandwidth, term of use (start date of use and expiration date), and reserved time zone (use start time and use end time) on a connection setting information entering screen presented as an initial screen on the display by the bandwidth reservation program 110 (step 111).

After completion of entering all data necessary for bandwidth reservation, first, a check is made to see a reserved time zone (step 112). When the reserved time zone is shorter than twenty-four hours, the inter-subnetwork path selection table 600 and the subnetwork selection table 700 for the reserved time zone on the start day of using the reserved bandwidth are generated (step 113).

The inter-subnetwork path selection table 600 generated here includes, as shown in FIG. 9, a plurality of line information entries 600-i (i=1 to n) in correspondence with the subnetwork IDs 610. The line information entry 600-i is comprised of a router ID 620, a line ID 630, next node information 640, line capacity 650 and a limited traffic information record corresponding to the reserved time zone. As a reserved bandwidth 670, the total value of reserved bandwidths on the start day of using the bandwidth (connection) reserved this time is set. As a vacant bandwidth 680, a statistic value calculated from actual record data of vacant bandwidths in the reserved time zone indicated in the subnetwork management table 60 of a past predetermined period (for example, one week or one month) is set.

In the subnetwork selection table 700 generated here, as shown in FIG. 10, an average vacant bandwidth 730 in the subnetwork in the reserved time zone 720 is shown in correspondence with a subnetwork ID 710. In this case, as the vacant bandwidth 730, a statistic value calculated from actual record data of average vacant bandwidths in the reserved time zone in the subnetwork bandwidth management table 70 in a past predetermined period is set.

When an applied reservation time zone has a length of a few hours and is, for example, the zone from 13:00 to 15:00, statistic values calculated from the vacant bandwidth actual record data in the time zone 13:00 to 14:00 and the time zone 14:00 to 15:00 in the subnetwork management table 60 (or subnetwork bandwidth management table 70) may be integrated as a single traffic information record of the time zone 13:00 to 15:00 on the inter-subnetwork path selection table 600 (or the subnetwork selection table 700). In this case, smaller one of the statistic value calculated in the time zone 13:00 to 14:00 and that calculated in the time zone 14:00 to 15:00 is selected and is used as a vacant bandwidth in the time zone 13:00 to 15:00 in a main statistic value table.

When the reserved time zone is designated as twenty-four hours, the inter-subnetwork path selection table 600 and the subnetwork selection table 700 for a full day on the reserved bandwidth use start day are generated (step 114). The inter-subnetwork path selection table 600 has a structure similar to that of the inter-subnetwork path selection table generated in step 113 and has average traffic information of one day (per hour). As the reserved bandwidth 670, an average value of bandwidths (cumulative value) which are reserved on the use start day of the bandwidth (connection) reserved this time is set. As the vacant bandwidth 680, a statistic value calculated from average vacant bandwidth actual record data of one day shown in the subnetwork management table 60 in a past predetermined period is set.

In the subnetwork selection table 700 generated here, a vacant bandwidth 730 as an average of one day (per hour) in the subnetwork is shown in correspondence with the subnetwork ID 710. In this case, as the vacant bandwidth 730, a statistic value calculated from the actual record data of the vacant bandwidth as an average of one day in the vacant bandwidth management table 70 in a past predetermined period is set. In the inter-subnetwork path selection table 600 and the subnetwork selection table 700 for full day, in place of the statistic value as an average of one day, for example, a statistic value in a specific time zone having the minimum vacant bandwidth may be applied.

In the bandwidth reservation program, in the inter-subnetwork path selection table 600 generated in the step 113 or 114, the relations among the subnetwork ID 610, a next node subnetwork ID 640A, and a vacant bandwidth 680 are checked, a representative connection line having the largest vacant bandwidth is selected from among a plurality of connection lines existing between two subnetworks specified by the subnetwork ID 610 and the next node subnetwork ID 640A, and unnecessary line information entries are erased from the inter-subnetwork path selection table 600 (step 115).

In the inter-subnetwork path selection table 600, the connecting relation between subnetworks is defined on assumption that a subnetwork indicated by the subnetwork ID 610 is on the upstream side of transmission data and a subnetwork indicated by the next node subnetwork ID 640A is on the downstream side.

Accordingly, for example, when it is assumed that a connection line L12ba between the routers 21B and 22A has the widest vacant bandwidth among connection lines extending from the subnetwork 1 to the subnetwork 2 shown in FIG. 1, in step 115, from among a plurality of line information entries associated with the subnetwork ID 610 for the subnetwork 1 on the inter-subnetwork path selection table 600, a line information entry related to a connection line L12da between the routers 21D and 22A and a line information entry related to a line connection L12dc between the routers 21D and 22C are erased from the table 600.

The status of lines extending from the subnetwork 2 to the subnetwork 1 is shown by a plurality of line information entries associated with the subnetwork ID 610 for the subnetwork 2. Therefore, the line having the widest vacant bandwidth extending from the subnetwork 2 to the subnetwork 1 and the line having the widest vacant bandwidth extending from the subnetwork 2 to the subnetwork 1 do not always coincide with each other.

In the inter-subnetwork path selection table 600 from which unnecessary line information entries are erased in step 115, all of selectable routes extending from one of two subnetworks to the other specified by the source point information and the destination point information designated by the network manager are extracted (step 116).

These routes are extracted as follows. For example, from the line information entries associated with the subnetwork ID 610 as a source point, a plurality of subnetwork IDs 640 as next nodes are specified. By retrieving the matching subnetwork ID 610 with respect to one of the plurality of subnetwork IDs 640, ID(s) of one or a plurality of subnetworks connected on the downstream side can be specified. In each of the source point subnetwork and the downstream-side subnetwork, the retrieving process is repeated on all of the selectable routes.

A line information entry in which the next node subnetwork ID coincides with an ID of a subnetwork already retrieved is eliminated from objects to be selected, and the above retrieving process is repeated until the next node subnetwork coincides the destination point subnetwork, thereby enabling all of the routes from the source point subnetwork to the destination point subnetwork to be extracted without retrieving the same subnetwork again.

The routes extracted in step 116 are expressed as a linked list of a plurality of line information entries, for example, in accordance with the order of retrieving the subnetworks. When the destination point subnetwork is next to the source point subnetwork, the linked list of the shortest route includes only one line information entry.

Subsequently, the optimum route between subnetworks is selected in accordance with the status of the reserved bandwidth and the vacant bandwidth from among the routes extracted in step 116 (step 117). When another subnetwork is interposed between the source point subnetwork and the destination point subnetwork, that is, when a linked list indicative of a route has a plurality of line information entries, the smallest value in the vacant bandwidths 670 included in the entries is used as the vacant bandwidth.

As the optimum route, for example, a route having the widest vacant bandwidth 680 is selected from among the routes each having a value obtained by subtracting the reserved bandwidth 670 from the line capacity 650, which is wider than the reserved bandwidth applied this time. When the routes have the same vacant bandwidth, for example, priority is given to a route which includes the smallest number of subnetworks interposed, or a route having the largest value of the average vacant bandwidth 730 in an interposed subnetwork by referring to the subnetwork selection table 700.

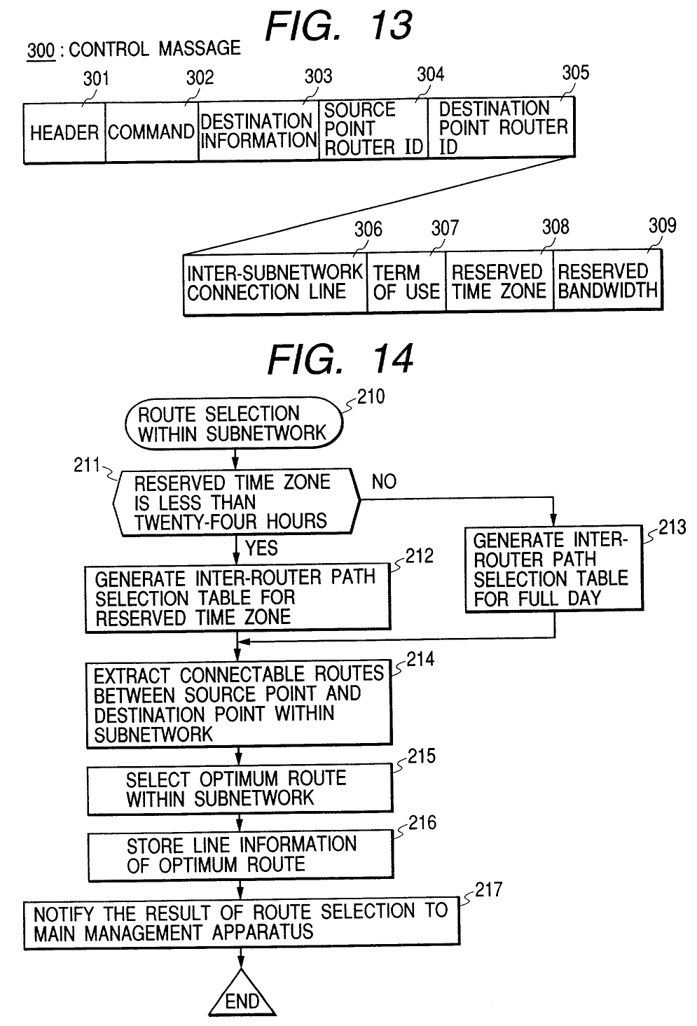

Finally, each of the sub management apparatuses for controlling the subnetworks on the optimum route including the source point and destination point subnetworks is instructed to set the optimum route in its subnetwork (step 118). An instruction of setting the optimum route is issued as, for example, as shown in FIG. 13, a control message 300 having a header 301 including the sub management apparatus as a destination address, a command 302, destination information 303, a source point router ID 304, a destination point router ID 305, an ID 306 of an inter-subnetwork connection line, term of use 307, a reserved time zone 308, and a reserved bandwidth 309.

The destination information 303 corresponds to the destination information 331 in the routing table shown in FIG. 3. In a message destined to the sub management apparatus in the source point subnetwork, a router ID included in the source point information entered by the network manager is set as the source point router ID 304, the value of the router ID 620 in the first line information entry in the linked list indicating the optimum route between subnetworks is set as the destination point router ID 305, and the value of the line ID 630 in the line information entry is set as the line ID 306.

In a control message destined to other sub management apparatuses, the value of the next node router ID 640B in a preceding line information entry in the linked list indicating the optimum route between subnetworks is set as the source point router ID 304, and the values of the router ID 620 and the line ID 630 in the relevant line information entry in the linked list are set as the destination point router ID 305 and the connection line ID 306, respectively.

For example, in the communication network shown in FIG. 1, it is assumed that the router 21A belonging to the subnetwork 1 is designated as a source point router, the router 23C belonging to the subnetwork 3 is designated as a destination point router, and the main management apparatus 100 selects a connection line L13db between the routers 21D and 23B as the optimum route between subnetworks. In this case, a control message 300 in which the router 21A is designated as the source point router ID 304, the router 21D is designated as the destination point router ID 305, and the connection line L13db is designated as the line ID 306 is issued to the sub management apparatus 11. A control message 300 in which the router 23B is designated as the source point router ID 304, the router 23C is designated as the destination point router ID 305, and the line ID 306 is blank is issued to the sub management apparatus 13.

FIG. 14 shows a flowchart of the inter-subnetwork path selection program 210 executed by each sub management apparatus in response to the control message 300.

In the route selection program 210, the reserved time zone 308 in the received control message 300 is checked (step 211). When the reserved time zone is shorter than twenty-four hours, the inter-router path selection table 500 in the reserved time zone on the reserved bandwidth use start day indicated by the term of use 307 in the received message 300 is generated (step 212).

In the inter-router path selection table 500 generated here, as shown in FIG. 6, the reserved bandwidth 560A and the vacant bandwidth statistic value 560C in the reserved time zone are shown in correspondence with the line ID 520 for each router (router ID 510). As the reserved bandwidth 560A, the total value of the reserved bandwidth in the reserved time zone on the reserved bandwidth use start day is set. As the vacant bandwidth statistic value 560C, a statistic value calculated from actual record data of the vacant bandwidth in the reserved time zone indicated in the router management table 50 of a past predetermined period is set.

In the case where twenty-four hours are designated as the reserved time zone, the inter-router path selection table 500 for full day on the reserved bandwidth use start day is generated (step 213). In the inter-router path selection table 500 for full day, an average value per hour in the reserved bandwidth on the reserved bandwidth use start day is set as the reserved bandwidth 560A. As the vacant bandwidth statistic value 560C, a statistic value calculated from vacant bandwidth actual record data as an average of one day (per hour) shown in the router management table 50 of a past predetermined period is set. In this case, in place of the statistic value as an average of one day (per hour), for example, a statistic value of a specific time zone having the minimum vacant bandwidth can be applied.

In the inter-router path selection table 500 generated in step 212 or 213, all of selectable routes between the source point router ID 304 to the destination point router ID 305 designated in the control message 300 are extracted (step 214).

These routes are extracted by retrieving an line information entry associated with the source point router from the inter-router path selection table 500 by using the source point router ID 304 as a retrieval key and finding an entry of which next node 530 matches the destination point router.

When the next node 530 of the retrieved line information entry does not match the destination point router, with reference to the inter-router path selection table by using the router ID indicated by the next node 530 as a retrieval key, it is determine whether the next node 530 in a newly retrieved line information entry matches the destination point router or not. When the next node 530 in the line information entry matches the router already passed, the entry is omitted from the selection. By repeating similar operations on all of the line information entries associated with the source point router until the next node 530 in the line information entry matches the destination point router, all of routes from the source point router to the destination point router can be extracted. The extracted routes can be expressed in a linked list of line information entries according to the routing order in a manner similar to the above-described inter-subnetwork route.

By executing the step 215, for example, in the subnetwork 1 shown in FIG. 1, a direct route from the source point router 21 to the destination point router, a route via the router 21B, a route via the router 21C, and a route via the routers 21B and 21C are extracted.

From among these routes, the optimum route within the subnetwork is selected according to the reserved bandwidth 560A and the vacant bandwidth statistic value 560C (step 215). In this case, in the route from the source point router 21 to the destination point router via another router, the smallest one of the vacant bandwidth statistic values 560C indicated in the plurality of line information entries in the linked list is regarded as the vacant bandwidth of the route. As the optimum route, for example, a route having the largest vacant bandwidth statistic value 560C is selected from among routes each having the value obtained by subtracting the reserved bandwidth 560A from the line capacity 540, which is larger than the reserved bandwidth applied this time.

Subsequently, the line information (linked list of line information entries) of the selected optimum route is stored with the control message 30 into the reservation table (step 216). After that, the result of the route selection within the subnetwork and the routing information is notified to the main management apparatus 100 (step 217), and the program is terminated.

Each sub management apparatus periodically checks the reservation table, reads out the line information entry reaching predetermined time on the use start day or the day before the use start day, and instructs each of routers on the route to set priority routing information.

By the instruction of setting the priority routing information, the source point router is notified of the destination information 303 indicated in the control message 300 and the line ID 520 shown in the line information entry having the ID 510 of the source point router. The destination router is notified of the destination information 303 and the line ID 306 shown in the control message 300. Each of the other routers positioned between the source point router and the destination point router is notified of the destination information 303 shown in the control message 300 and the line ID 520 indicated by the line information entry having the ID 510 of the router.

Each of the routers having received the instruction of setting the priority routing information sets the relation between destination information and the line ID designated by the sub management apparatus in the routing table 33. When the routing table 33 has the structure of FIG. 3A, the line ID designated by the sub management apparatus is stored as the reservation port number 332A. When the routing table 33 has the structure of FIG. 3B, the line ID designated by the sub management apparatus is stored as the output port number 332, and the bit “1” is set in the priority indication 333. By the setting, each of the routers can transfer a received packet having a destination address corresponding to the above destination information via the route designated by the main management apparatus and the sub management apparatus.

In the foregoing embodiment, the network manager performs a reserving operation a few days before the reserved bandwidth use start day, and each sub management apparatus instructs each router to set the priority routing information in accordance with the reserved bandwidth use start day. However, if the routing table may be updated immediately in response to the reserving operation by the network manager, in step 216 in the program for route setting within a subnetwork shown in FIG. 14, it is sufficient to instruct each of the routers on the optimum route to set the priority routing information.

In the embodiment, when the network manager designates the source point and the destination point of a connection for which the bandwidth is to be reserved, the main management apparatus selects the optimum route from the source point subnetwork to the destination point subnetwork, and each of the sub management apparatuses on the route automatically selects the optimum route from the source point router to the destination point router in each subnetwork. The following manner is also possible.

The main management apparatus automatically selects also the optimum route in the opposite direction from the destination point subnetwork to the source point subnetwork on the basis of the source point information and destination point information entered by the network manager, and each of the sub management apparatuses on the route automatically selects the optimum route in the opposite direction within each subnetwork in response to an instruction from the main management apparatus. This can be realized by executing the steps 115 to 118 again while replacing the source point information and the destination point information with each other in the flowchart shown in FIG. 12.

In the embodiment, one day is divided into a plurality of time zones and a statistic value of a vacant bandwidth (vacant line capacity) in each time zone is calculated from actual record data of a past predetermined period. However, the use status of a line fluctuates depending on, for example, the day of the week or seasons, and there can be a day on which actual record data seems to be obviously abnormal when determined from preceding and subsequent data appears. For example, in the case where a connection of which reserved time zone is limited to the specific day of the week is used as a presumption, only actual record data having periodicity to a certain extent may be used at the time of calculating a statistic value in order to eliminate abnormal data, for example, by using actual record data on the same day of the week. In this case, in place of the average value, the smallest value of the vacant bandwidth in each time zone may be employed. A statistic value calculating method adapted to the trends of traffic can be adopted.

A process performed in the case where route selection fails in the sub management apparatus has not been described in the above embodiment. In the case where a notification of failure in route selection is received from a specific sub management apparatus, the main management apparatus instructs other sub management apparatuses to which the route setting instruction has been already given to cancel the route setting, and re-selects a new route from which the subnetwork controlled by the specific sub management apparatus is eliminated or a route in which the source point router or destination point router in the subnetwork under the control of the specific sub management apparatus is changed to another router.

In order to shorten the time required for the process of re-selecting the inter-subnetwork route, for example, it is also possible to preliminarily select the optimum route and the next-optimum route in step 117 in FIG. 12 and, when a problem occurs in any of the subnetworks in the optimum route, give a route setting instruction to the sub management apparatus related to the next-optimum route. In this case, cancellation of the route setting is notified to a sub management apparatus out of the next-optimum route and a sub management apparatus of which route setting conditions are changed and route setting is instructed to a sub management apparatus newly related to the next-optimum route and a sub management apparatus of which route setting conditions are changed.

Alternately, by separating the route selection and route setting within a subnetwork, the main management apparatus may instruct the route setting to the related sub management apparatuses when all of the subnetworks succeed in route selection, thereby enabling the route change to be facilitated.

According to the network configuration described in the embodiment, each of a plurality of sub management apparatuses executes the operation of selecting an optimum route in its subnetwork in response to an instruction from the main management apparatus and, as a result, the route setting operations are executed in the plurality of subnetworks in parallel. Consequently, even when the network scale enlarges, the route selection and route setting can be promptly carried out. The advantage is not limited to the route selection in the priority routing performed in association with the bandwidth reservation shown in the embodiment but is also effective, for example, in the case where a router having insufficient routing information to transfer a received packet issues a route selection request to the main management apparatus via a sub management apparatus, and routing information selected by the main management apparatus or the sub management apparatus is used.

Generally, a conventional router transfers a received packet in accordance with autonomously set routing information unless a route is preliminarily designated from the outside. In a communication system called MPLS (Multi Protocol Label Switch) proposed in recent years, it is necessary to set destinations one after another from a source point router to a destination point router. Consequently, the system has a problem such that it takes long time to set routing information when the network scale is large. The problem can be solved by selecting the inter-subnetwork connection route between the source point router and the destination point router by using the function of the main management apparatus 100 shown in FIG. 1 and, in each of subnetworks on the route, performing route setting between routers in each subnetwork and between neighboring subnetworks in parallel.

As obviously understood from the above description, according to the invention, in a communication network constructed by a plurality of packet transfer apparatuses each having the function of autonomously setting routing information, the network management apparatus instructs each of the packet transfer apparatuses on the bandwidth-reserved route to set routing information, and each of the packet transfer apparatuses preferentially handles the routing information designated by the network management apparatus, so that packet transferring service through a route of an excellent traffic status can be offered to a user who has reserved a bandwidth.

What is claimed is:

1. A packet transfer control method in a communication network having a plurality of packet transfer apparatuses connected to a management apparatus, each of said packet transfer apparatuses executing the steps of:
updating a routing table on the basis of routing information designated by said management apparatus;
autonomously collecting routing information and updating said routing table; and
routing a received packet with reference to said routing table by placing priority on the routing information designated by said management apparatus over the routing information autonomously collected.

2. A packet transfer control method according to claim 1, further comprising the steps of:
notifying line information including a line identification and traffic status information from each of said packet transfer apparatuses to said management apparatus;
storing the line information notified from each of said packet transfer apparatuses by said management apparatus;
selecting an optimum route according to a bandwidth reservation request from said stored line information of a predetermined period by said management apparatus when the bandwidth reservation request in which a source point and a destination point of a connection are designated is received from the outside; and
instructing from said management apparatus to each of packet transfer apparatuses on said optimum route to set routing information for transferring transmission packets based on said bandwidth reservation through said optimum route.

3. A packet transfer control method according to claim 2, wherein
said management apparatus stores traffic information notified from each of said packet transfer apparatuses as traffic information for each of time zones and, when said bandwidth reservation request is received, selects an optimum route for said request on the basis of traffic information corresponding to a use time zone of the reserved bandwidth.

4. A packet transfer control method according to claim 1, wherein
said management apparatus comprises a plurality of sub management apparatuses each connected to a group of packet transfer apparatuses which form a subnetwork and, a main management apparatus connected to said plurality of sub management apparatuses, and
said main management apparatus determines a route among subnetworks, and each of the sub management apparatuses having received an instruction from said main management apparatus determines a route within the subnetwork under the control and notifies routing information to each of packet transfer apparatuses on the route within said subnetwork.

5. A packet transfer control method according to claim 1, wherein
said management apparatus comprises a plurality of sub management apparatuses each connected to a group of packet transfer apparatuses which form a subnetwork and, a main management apparatus connected to said plurality of sub management apparatuses, and
said method comprises the steps of:
notifying line information including a line identification and traffic status information from each of said packet transfer apparatuses to the sub management apparatus in each of said subnetworks;
storing the line information notified from each of said packet transfer apparatuses by each of said sub management apparatuses;
notifying line information regarding a connection line between subnetworks from each of said sub management apparatuses to said main management apparatus;
storing the line information notified from said sub management apparatus by said main management apparatus;
selecting by said main management apparatus when a bandwidth reservation request in which a source point and a destination point of a connection are designated is received from the outside, an optimum route between subnetworks adapted to said request on the basis of statistic data obtained from said stored line information of a predetermined period, and instructing each of the sub management apparatuses controlling the subnetworks on said optimum route to select a route within the subnetwork adapted to said request; and
selecting, by each of the sub management apparatuses having received the instruction of route selection from said main management apparatus, an optimum route between subnetworks adapted to said instruction on the basis of statistic data obtained from stored line information of a predetermined period, and instructing each of packet transfer apparatuses on said optimum route to set routing information for transferring transmission packets based on said bandwidth reservation through said optimum route.

6. A packet transfer apparatus having a plurality of input and output ports, for transferring a received packet from each of the input ports to any of the output ports in accordance with header information, comprising:
a routing table storing routing information in correspondence with destination information to be included in a header of the received packet;
means for autonomously collecting the routing information in cooperation with other packet communication apparatuses forming a communication network, and updating said routing table;
means for updating said routing table on the basis of routing information designated by a management apparatus; and
means for determining a destination of a received packet with reference to said routing table by giving priority on the routing information designated by said management apparatus over the routing information autonomously collected and routing the received packet to any of said output ports.

7. A packet transfer apparatus according to claim 6, further comprising means for monitoring traffic of each of said output ports and notifying the management apparatus of status information of the traffic.

8. A packet communication network comprising:
a plurality of packet transfer apparatuses each belonging to any of subnetworks constructing a packet communication network;
a plurality of sub management apparatuses each connected to a group of packet transfer apparatuses included in a subnetwork under the control of the sub management apparatus; and
a main management apparatus connected to said plurality of sub management apparatuses,
said main management apparatus having means for determining a route among subnetworks with respect to a connection for which a bandwidth is reserved and instructing each of sub management apparatuses controlling subnetworks on the route to select a route within the subnetwork, and
said sub management apparatus having: means for determining a route within the subnetwork under the control of the sub management apparatus in response to the route selection instruction from said main management apparatus; and means for instructing each of packet transfer apparatuses on the route in said subnetwork to set routing information.

9. A packet communication network according to claim 8, wherein each of said packet transfer apparatuses comprises:
a routing table for storing routing information in correspondence with destination information to be included in a header of a received packet;
means for autonomously collecting the routing information in cooperation with other packet communication apparatuses forming said communication network, and updating said routing table;
means for updating said routing table on the basis of routing information designated by said sub management apparatus; and
means for determining a destination of a received packet with reference to said routing table by giving priority on the routing information designated by said management apparatus over the routing information autonomously collected and routing the received packet to any of said output ports.
